(19) United States
(12) Patent Application Publication
(10) Pub. No.: US 2013/0275221 A1
(43) Pub. Date: Oct. 17, 2013

(54) SYSTEM AND METHODS FOR DELIVERING TARGETED MARKETING CONTENT TO MOBILE DEVICE USERS BASED ON GEOLOCATION

(71) Applicant: MobileBits Corporation, Sarasota, FL (US)

(72) Inventors: Michael J. Zeto, III, Atlanta, GA (US); David Rippetoe, Nokomis, FL (US); David Shaw, Buford, GA (US); Angela Renee Mercer, Buford, GA (US); Gilberto Gaxiola, Jr., Smyrna, GA (US); Ronald Tyrone Williams, Clarkston, GA (US); Eric Anders Oscar Johansson, Atlanta, GA (US)

(21) Appl. No.: 13/911,956

(22) Filed: Jun. 6, 2013

Related U.S. Application Data
(63) Continuation-in-part of application No. 13/216,054, filed on Aug. 23, 2011.
(60) Provisional application No. 61/376,150, filed on Aug. 23, 2010.
(60) Provisional application No. 61/656,370, filed on Jun. 6, 2012.

(51) Int. Cl. G06Q 30/02

(52) U.S. Cl. CPC G06Q 30/0261
USPC 705/14.58

(57) ABSTRACT

The present disclosure relates generally to proximity-based advertising and marketing systems, and more particularly to methods and systems for the creation, syndication, and distribution of advertising and marketing content to consumer mobile devices based at least in part on a physical, geo-location or proximity of the mobile devices. In particular, the present disclosure relates to systems and methods for creating predefined regions and associating mobile content items to such predefined regions.

### CROSS REFERENCE TO RELATED APPLICATION

This application is a continuation-in-part application and claims the benefit of and priority under 35 U.S.C. §120 to U.S. patent application Ser. No. 13/216,054, filed Aug. 23, 2011, and entitled “Systems and Methods for Delivering Proximity-Based Marketing Content to Mobile Devices”, which in turn claims benefit under 35 U.S.C. §119(e) of U.S. Provisional Patent Application No. 61/376,150, filed Aug. 23, 2010, and entitled “Proximity Marketing Platform”, both of which are incorporated herein by reference as if set forth herein in their entirety.

In addition, this application claims benefit under 35 U.S. C. §119(e) of U.S. Provisional Patent Application No. 61/656,370, filed Jun. 6, 2012, and entitled “Systems and Methods for Delivering Targeted Content to Mobile Device Users Based on Geo-Location”, which is incorporated herein by reference as if set forth herein in its entirety.

In addition, this application is related to and incorporates by reference herein the following U.S. patent applications:

U.S. patent application Ser. No. ______, filed ______, entitled “______” and

U.S. patent application Ser. No.______, filed ______, entitled “______,” the disclosures of which are incorporated herein by reference as if set forth herein in their entirety.

### TECHNICAL FIELD

The present disclosure relates generally to proximity-based advertising and marketing systems, and more particularly to methods and systems for the creation, syndication, and distribution of advertising and marketing content to consumer mobile devices based at least in part on a physical, geo-location or proximity of the mobile devices.

### BACKGROUND

Mobile devices (e.g., cellular phones, smartphones, PDAs, tablet computers, etc.) have become ubiquitous personal items that are carried by the vast majority of the population. These mobile devices are generally capable of a variety of tasks (in addition to making telephone calls), including browsing the Internet, downloading and using software applications (or “apps”), messaging (e.g., “text” messaging in the form of SMS and MMS messages), performing emailing and calendaring functions, and a variety of other functionalities.

Due to a typical person's frequent interaction with his or her mobile device, companies and marketers have identified mobile devices as a fertile ground for advertising and delivering other types of content. Unfortunately, however, it can be difficult to transmit such content directly to mobile device users. For example, to view a company's web page on a mobile device, the user typically must be aware of the company and make a conscious decision to visit the company's page. Even then, the web page content may be generic to the company as a whole, and not targeted to the user's particular needs or interest, or purchasing decisions that immediately impact the user. Additionally, physical retail or merchant locations (such as stores, casinos, hotels, resorts, restaurants, and the like) often desire to increase business in terms of attracting consumer foot traffic. Further, such retail locations often prefer to use discounts or coupons to attract consumers, but it can be difficult to get those coupons into consumers' hands. Moreover, it can be challenging to track the effectiveness or success of various marketing campaigns. Likewise, retail and merchant locations often desire to reward long-term and loyal customers as well as re-engage former customers. Further, instead of providing a coupon or reward that could be redeemed at an affiliated retailer's location, certain merchants and retailers would prefer to provide coupons or rewards or other mobile content items that only are redeemable at a particular, specific location.

Accordingly, there is a long-felt but unresolved need for a system or method that is able to effectively distribute marketing content (and other types of content) to the mobile devices of consumers. There is a further need to be able to grab the attention of consumers that are at or in the proximity of a physical retail location and attract those consumers to the retail location (or encourage them to make a purchase at the location). Additionally, there is a need for a system or method that can track the effectiveness of various types of marketing content and consumer interaction with that content, and generate consumer profiles that identify consumer purchasing trends. Further, there is a need for a system or method that can present users with rewards that are only redeemable at a particular location. Finally, there is a need for a system or method that allows merchants and retailers to reward loyal customers and to re-engage former customers.

### BRIEF SUMMARY OF THE DISCLOSURE

Aspects of the present disclosure generally relate to systems and methods for delivering proximity-based marketing content to mobile devices. According to one aspect, a Location-based Offer Delivery System (“LODS”) allows a subscriber who has opted in to the service to receive targeted offers (e.g., advertising content, promotional offers, discounts, interactive promotional content, etc.) from a plurality of merchants (e.g., retail stores, shopping malls, restaurants, etc.) associated with a property. The LODS determines which targeted offers to send to which subscribers based on subscriber location (specifically, location of the subscriber's mobile device) in relation to a particular property, subscriber-defined preferences, and business rules software. According to one aspect, a subscriber's location relative to a particular property (e.g., retailer, shopping mall, etc.) is determined based on a fixed or user-determined radius or geofence as determined by a designated representative of the property, retailer, shopping mall, etc. According to one aspect, a geofence or predefined region can be a circle defined by a point and a radius of predetermined distance. For example, a property's designated representative may base the point of a property's geofence on the property's physical location (e.g., address, latitude/longitude coordinates, etc.). Based on the selected point, the representative selects a radius distance to create a circular geofence. Subscribers who enter the property's geofence are eligible to receive offers, generally on a mobile device via a standard SMS message or other delivery mechanism including push notifications within a mobile application.

According to one embodiment, companies or marketers generate content to be distributed to mobile devices (e.g., cellular telephones, smartphones, etc.) of consumers as those consumers become geographically proximate to physical locations associated with the companies or marketers (i.e., when consumers enter predefined geofences or predefined regions associated with the location). According to one embodiment, a central application server is used for purposes of generating and managing marketing content, and that content is transmitted to various client devices. In one aspect, the central application receives location information from a user's mobile device, and using user profile information, pushes user- and location-specific marketing content to the user's mobile device. In various embodiments, the consumers can then view marketing content, or “redeem” offers contained within the marketing content, for example, by showing the offer displayed on the consumer's mobile device to a representative at the physical company or marketer location, or by engaging in some other redemption mechanism (described in greater detail below).

Additionally, in one embodiment, aspects of the present system allow companies or marketers to generate geofences of progressively-increasing diameters (i.e., concentric geofences) around a particular physical location. According to one aspect, companies or marketers can then create varying content to be distributed to consumers' mobile devices based on the concentric geofence into which the consumer has entered. For example, a marketer may create three concentric geofences around a particular location: a first having a quarter-mile radius around the location (“Geofence A”), a second having a one-mile radius (“Geofence B”), and a third having a five-mile radius (“Geofence C”). In one embodiment, a consumer who enters Geofence C may be entitled to, for example, a coupon for a 5% discount. If the same consumer enters Geofence B, however, the consumer may be entitled to a coupon for a 10% discount. Finally, if the same consumer enters Geofence A, the consumer may be entitled to a 20% discount.

According to yet a further embodiment, aspects of the present disclosure may track consumer interaction with marketing content over time to provide helpful analytics and insight into consumer purchasing behavior, the success of different types of marketing content, the success of different types of delivery mechanisms (e.g., Bluetooth v. Wi-Fi), the physical movement patterns of consumers (e.g., through a shopping mall, casino, sports stadium, etc.), and other related marketing performance information. In other embodiments, this marketing performance information may be used to build consumer profiles for individual consumers such that subsequent marketing content may be specifically targeted or tailored to that user's preferences. For example, if it is determined over time that a given consumer only engages with certain types of content delivered via aspects of the present system, then those types of content can be highlighted and specifically sent to that consumer in the future, regardless of whether the consumer is proximate to a physical company or marketer location or not. In this example, if it becomes apparent that a given consumer will often respond to discount offers in connection with men's clothing, then certain men's clothing marketers may begin to send such discount content to the consumer's mobile device (based on pre-stored contact information) on a periodic basis, regardless of the consumer's physical location. Further, if it becomes apparent that a consumer once frequented a particular retailer but has not patronized the location in some time, the present system may deliver discount content or other content in an effort to draw the customer back to the retailer.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary system environment in which an embodiment of the disclosed Location-based Offer Delivery System (“LODS”) is utilized.

FIG. 2 is a flowchart showing an exemplary computer-implemented geofence creation process, according to one embodiment of the present disclosure.

FIG. 3 (including FIGS. 3A and 3B) is a flowchart showing an exemplary computer-implemented process for creating a custom geofence, according to one embodiment of the present disclosure.

FIG. 4 is a flowchart showing an exemplary computer-implemented process for delivering mobile content items to subscribers via a mobile carrier network, according to one embodiment of the present disclosure.

FIG. 5 is a flowchart showing an exemplary computer-implemented process for delivering mobile content items to subscribers via a network, according to one embodiment of the present disclosure.

FIG. 6 is a flowchart showing an exemplary computer-implemented location-restricted offer redemption process, according to one embodiment of the present disclosure.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for delivering proximity-based marketing content to mobile devices. According to one aspect, a Location-based Offer Delivery System (“LODS”) allows a subscriber who has opted in to the service to receive targeted offers (e.g., advertising content, promotional offers, discounts, interactive promotional content, etc.) from a plurality of merchants (e.g., retail stores, shopping malls, restaurants, etc.) associated with a property. The LODS determines which targeted offers to send to which subscribers based on subscriber location (specifically, location of the subscriber's mobile device) in relation to a particular property, subscriber-defined preferences, and business rules software. According to one aspect, a subscriber's location relative to a particular property (e.g., retailer, shopping mall, etc.) is determined based on a fixed or user-determined radius or geofence as determined by a designated representative of the property, retailer, shopping mall, etc. According to one aspect, a geofence can be a circle defined by a point and a radius of predetermined distance. For example, a property's designated representative may base the point of a property's geofence on the property's physical location (e.g., address, latitude/longitude coordinates, etc.). Based on the selected point, the representative selects a radius distance to create a circular geofence. Subscribers who enter the property's geofence are eligible to receive offers, generally on a mobile device via a standard SMS message or other delivery mechanism including push notifications within a mobile application.

According to one embodiment, companies or marketers generate content to be distributed to mobile devices (e.g., cellular telephones, smartphones, etc.) of consumers as those consumers become geographically proximate to physical locations associated with the companies or marketers (i.e., when consumers enter predefined geofences). According to one embodiment, a central application server is used for purposes of generating and managing marketing content, and that content is transmitted to various client devices. In one aspect, the central application receives location information from a user's mobile device, and using user profile information, pushes user- and location-specific marketing content to the user's mobile device. In various embodiments, the consumers can then view marketing content, or “redeem” offers contained within the marketing content, for example, by showing the offer displayed on the consumer's mobile device to a representative at the physical company or marketer location, or by engaging in some other redemption mechanism (described in greater detail below). Additionally, in one embodiment, aspects of the present system allow companies or marketers to generate geofences of progressively-increasing diameters (i.e., concentric geofences) around a particular physical location. According to one aspect, companies or marketers can then create varying content to be distributed to consumers' mobile devices based on the concentric geofence into which the consumer has entered. For example, a marketer may create three concentric geofences around a particular location: a first having a quarter-mile radius around the location (“Geofence A”), a second having a one-mile radius (“Geofence B”), and a third having a five-mile radius (“Geofence C”). In one embodiment, a consumer who enters Geofence C may be entitled to, for example, a coupon for a 5% discount. If the same consumer enters Geofence B, however, the consumer may be entitled to a coupon for a 10% discount. Finally, if the same consumer enters Geofence A, the consumer may be entitled to a 20% discount.

According to yet a further embodiment, aspects of the present disclosure may track consumer interaction with marketing content over time to provide helpful analytics and insight into consumer purchasing behavior, the success of different types of marketing content, the success of different types of delivery mechanisms (e.g., Bluetooth v. Wi-Fi), the physical movement patterns of consumers (e.g., through a shopping mall, casino, sports stadium, etc.), and other related marketing performance information. In other embodiments, this marketing performance information may be used to build consumer profiles for individual consumers such that subsequent marketing content may be specifically targeted or tailored to that user's preferences. For example, if it is determined over time that a given consumer only engages with certain types of content delivered via aspects of the present system, then those types of content can be highlighted and specifically sent to that consumer in the future, regardless of whether the consumer is proximate to a physical company or marketer location or not. In this example, if it becomes apparent that a given consumer will often respond to discount offers in connection with men's clothing, then certain men's clothing marketers may begin to send such discount content to the consumer's mobile device (based on pre-stored contact information) on a periodic basis, regardless of the consumer's physical location. Further, if it becomes apparent that a consumer once frequented a particular retailer but has not patronized the location in some time, the present system may deliver discount content or other content in an effort to draw the customer back to the retailer.

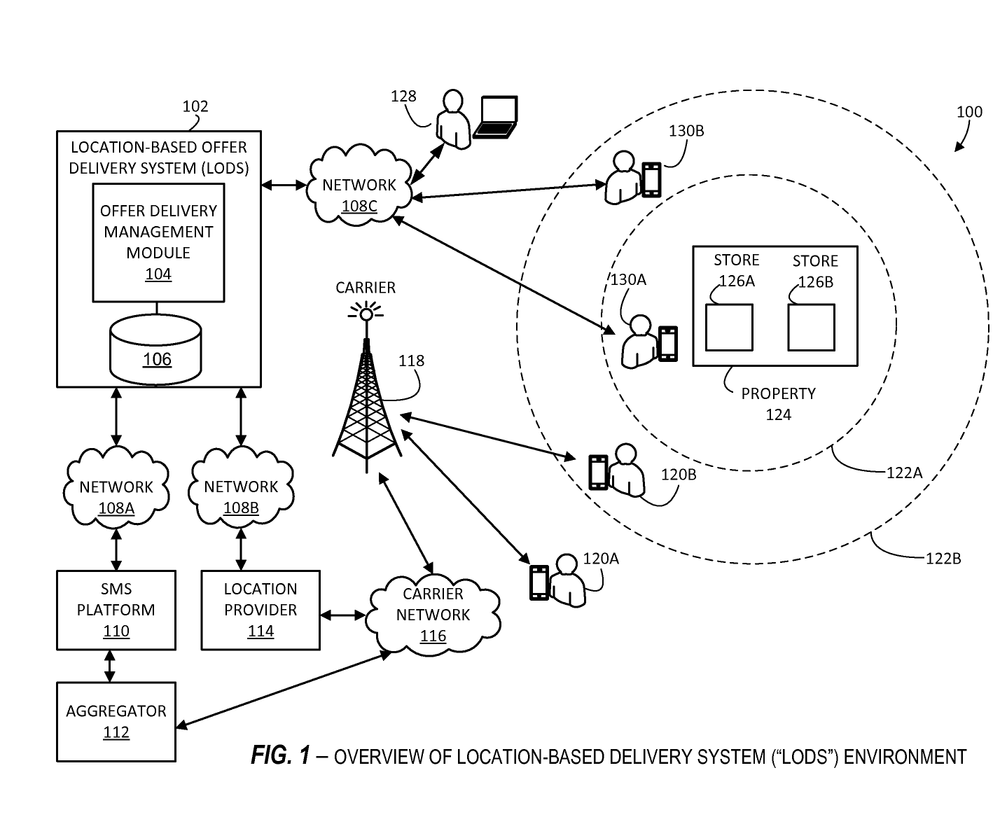

Referring now to the figures, FIG. 1 illustrates an overview 100 of a Location-based Offer Delivery System (“LODS”) 102 in an exemplary environment, constructed and operated in accordance with various aspects of the present disclosure. As shown in FIG. 1, the LODS 102 comprises an Offer Delivery Management Module (“ODMM”) 104, which is a LODS central server for carrying out various computer-implemented processes of the LODS 102. Embodiments of the LODS 102 further include various databases 106 for storing system data.

According to the FIG. 1 embodiment, the LODS 102 is operatively connected to a location provider 114 and an SMS platform 110 through networks 108A and 108B, such as the Internet. As will be understood, a location provider 114 is a third-party provider that transmits opted-in individuals' location data to providers. As will be further understood and according to one embodiment, an SMS platform 110 receives offer messages from a provider and transforms the messages in to SMS messages that can be received on a mobile device. Typically, such operative connections involve a secure connection or communications protocol, and communications over a network typically involve the use of one or more services such as a Web-deployed service with client/server architecture, a corporate Local Area Network (“LAN”) or Wide Area Network (“WAN”), or through a cloud-based system.

The LODS 102 includes operative (and preferably wireless) connections to subscribers 120A and 120B via a carrier network 116. Although FIG. 1 only shows one carrier network 116, it will be understood and appreciated by a person of ordinary skill in the art that multiple networks may be connected to an LODS 102. Further, as shown in the FIG. 1 embodiment, the LODS 102 also includes operative (and preferably wireless) connections to subscribers 130A and 130B and user 128 via network 108C, which may be the Internet according to one embodiment. Moreover, various networking components such as routers, switches, hubs etc., are typically involved in such communications, and although not shown in FIG. 1, certain embodiments of the present disclosure may include one or more secure networks, gateways/firewalls that provide information security from unwarranted intrusions and cyber-attacks.

As noted, according to the embodiment shown in FIG. 1, the LODS 102 is in operative communication with one or more subscribers 120A & B, subscribers 130A & B, and user 128 through a carrier network 116 or a network 108C such as the Internet. According to one aspect, subscribers are eligible to receive offers based on their location in relation to geofences (e.g., geofences 122A and 122B), as further shown in FIG. 1. As used herein, the term “geofence” generally refers to a virtual perimeter around a location such as a store, restaurant, shopping mall, or other example as will occur to one skilled in the art, wherein the location itself is defined as a point. For example, and according to one aspect, a subscriber (e.g., 120B, 130A, or 130B) who enters a particular geofence may become eligible to receive an offer from a retailer or store. For example, as shown in FIG. 1, subscriber 130A has entered geofence 122A and thus may be eligible to receive an offer or reward from store 126A or 126B, or the property 124 (i.e., where stores 126A and 126B are located).

As will be discussed herein, the LODS 102 may receive information relating to a user's location from the user's mobile device. According to one embodiment, the LODS 102 may receive such location information via a carrier network 116. According to further embodiments, the LODS 102 may receive such location via a network 108C from other methods such as a mobile device's GPS, A-GPS, IP address, Wi-Fi, Google Services, etc.

As shown in the FIG. 1 embodiment, geofences 122A and 122B are concentric geofences encircling stores 126A and 126B as well as property 124, any of which could be the enter point for the geofences 122A and 122B. As will be discussed, users may utilize the LODS 102 to create multiple geofences for a single property (i.e., store, shopping mall, retailer, etc.), and each geofence may be associated with a different offer, coupon, reward, etc. In one embodiment, rewards or other offers may get progressively more valuable or desirable as a subscriber gets closer to the property (e.g., as subscriber 130B moves from geofence 122B into geofence 122A). Further, while not shown in FIG. 1, it will be understood that in addition to circular, geofences can take on various other user-specified shapes.

Additionally, according to the embodiment shown in FIG. 1, a user 128 may also interact with an LODS 102. In various embodiments, a user 128 as mentioned herein may comprise a company, marketer, individual user, organization, and virtually any other user or group that is desirous of distributing marketing content or other types of content to mobile device users. Further, users 128 generally may include a super user, a company administrator, campaign creator, and general users. These users may log into the application server to create campaigns, dispatch campaigns to the devices and view performance reports. According to one aspect, an LODS 102 receives various input from a user 128 including, for example, offer message headers and footers, dayparting information (i.e., when an LODS 102 should send a particular offer), how often an offer should be sent, and other information as will occur to one skilled in the art.

As will be understood and appreciated, the various modules and managers referred to herein (and, specifically in connection with FIG. 1) generally comprise computer software algorithms, modules, routines or subroutines, or other computer languages capable of performing various process and function steps.

The discussions above in association with FIG. 1 are merely intended to provide an overview of an embodiment of the present system for delivering targeted marketing offers to subscribers based on subscribers' locations in relation to various geofences. Accordingly, it will be understood that the descriptions in this disclosure are not intended to limit in any way the scope of the present disclosure. Various architectural details of an embodiment of the disclosed LODS 101 will be described next in greater detail.

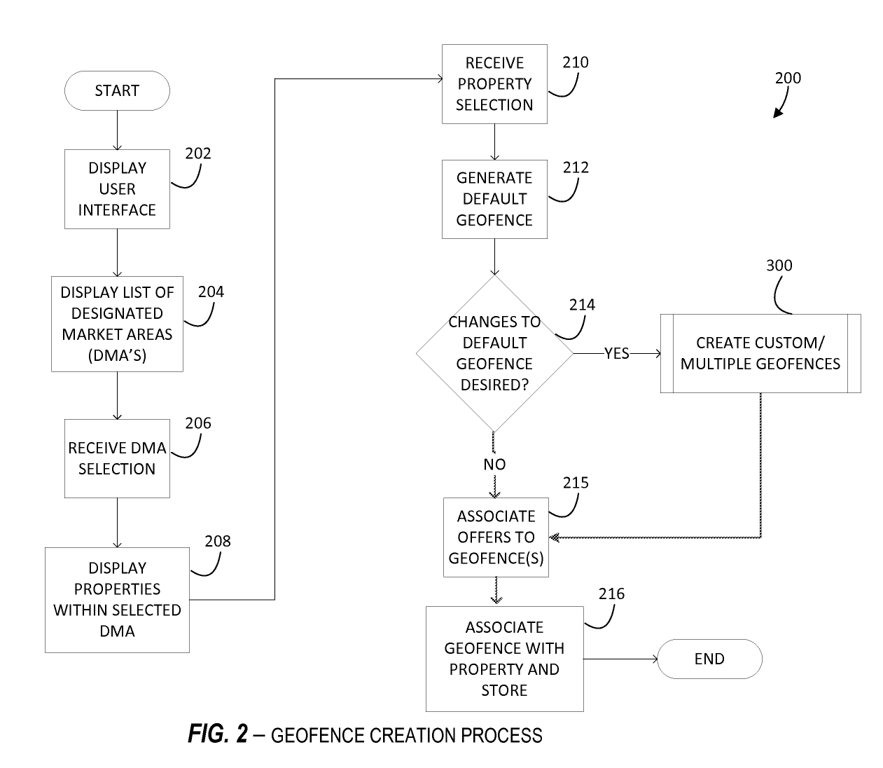

FIG. 2 illustrates an exemplary Geofence Generation Process 200 that is performed by various modules and software components associated with an embodiment of an LODS 102 for purposes of generating geofences associated properties. As will be understood, the operations of the process shown in FIG. 2 and various processes of an LODS 102 may operate concurrently and continuously. Accordingly, the operations shown in FIG. 2 are generally asynchronous and independent, computer-implemented, tied to particular machines, and not necessarily performed in the order shown.

Starting at operation 202, according to one embodiment, the LODS 102 displays a user interface to a representative of a single entity (i.e., a user), wherein the user is responsible for defining a geofence associated with a single property. For example, a shopping mall may be designated as a single property, and the single entity responsible for defining a geofence for the property, i.e., the user, may be a representative of the shopping mall, a marketing firm acting on the shopping mall's behalf, or other entity that will occur to one skilled in the art. In another example, a retailer or merchant could be designated as the single property, and the user could act on behalf of the retailer or merchant. According to one aspect of the present example, in addition to being responsible for defining a geofence associated with the shopping mall, the user is also responsible for managing offers and other information behalf of the stores or merchants located within the shopping mall.

Once the LODS 102 displays a user interface to a user (entity representative), the LODS 102 typically displays to the user a list of Designated Market Areas (“DMAs”), as shown at operation 204. As will be understood by one skilled in the art and as used herein, DMAs are predefined geographical market regions. According to one embodiment, a user is able to select the DMA within which an entity is located. Generally, an LODS 102 then receives the user's DMA selection, as shown at operation 206. According to one aspect, upon receipt of a DMA selection, the LODS 102 typically displays a list of properties located within the geographical bounds of the selected DMA, as shown in operation 208. As will be understood, a given DMA may contain any number of properties depending on the predefined geographical area comprising the DMA.

Generally, once the user selects a particular property from the list displayed at operation 208, an embodiment of the LODS 102 receives the property selection, as shown at operation 210. According to one embodiment, once the LODS 102 receives a property selection, the system generates a default geofence for the property, as shown at operation 212. According to one aspect, a property is associated with a “point” (i.e., a particular latitude and longitude point), and the LODS 102 creates a default circular geofence using the property's point as the circle's center. In one embodiment, the LODS 102 uses a default radius of one mile. As will be understood and according to one aspect, default geofence parameters such as radius length can be set based on the preferences of the user responsible defining a property's geofences and are not limited to radius length. Further, according to one alternate embodiment, a user can choose to create a geofence based on a point that is selected from a map and is unassociated with any property selection or designated marketing area.

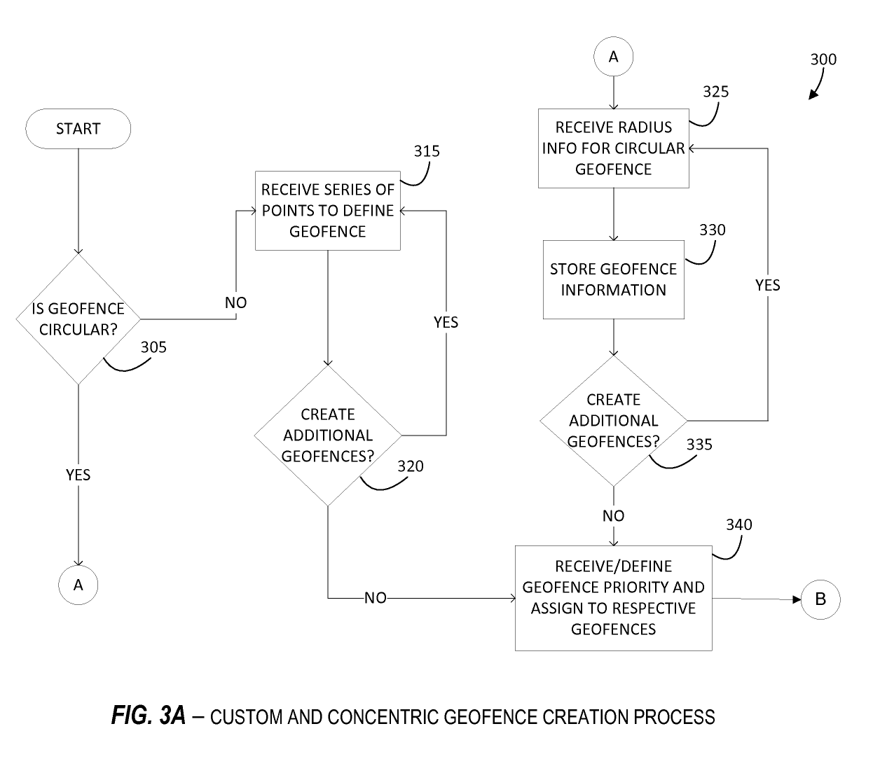

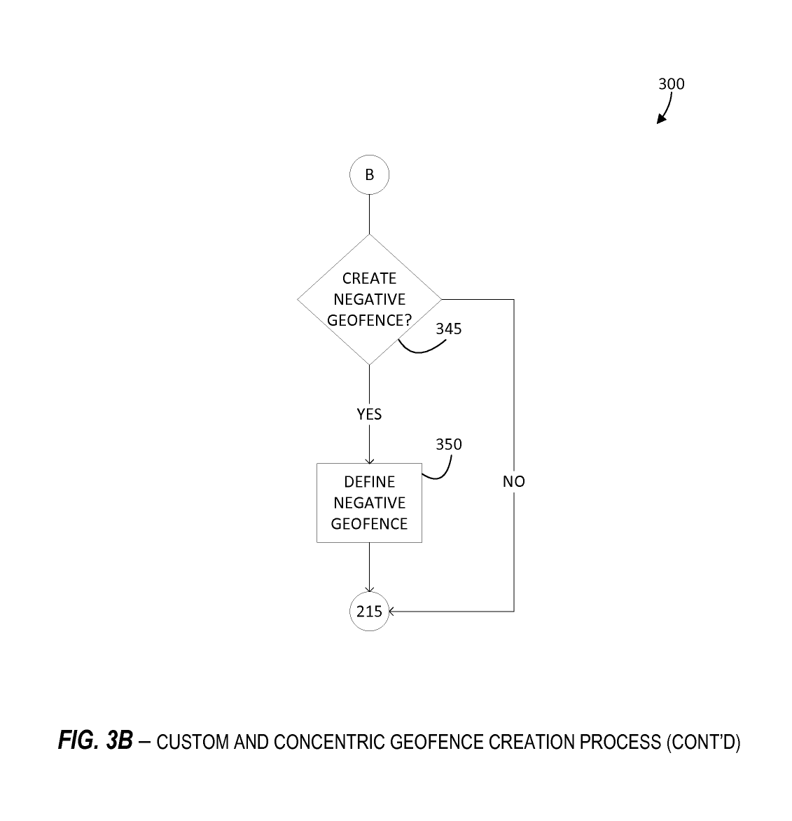

According to one aspect, after generating a default geofence, the LODS 102 generally determines whether the user wants to input custom geofence information or create multiple geofences for a single location, thus overriding the default settings, as shown at operation 214. If the system 102 determines the user wishes to create a custom geofence or multiple geofences, the system 102 transitions to the custom geofence creation subroutine 300, which will be discussed in relation to FIG. 3.

According to one embodiment, if a user does not want to override the default geofence settings or if a user has created custom or multiple geofences, at operation 215, the system associates one or more mobile content items (e.g., rewards, coupons, messages, images, mobile webpages, etc.) to the particular geofence or geofences. In one embodiment, a user can associate multiple mobile content items to a particular geofence. For example, a sporting goods store may create various mobile content items geared towards shoppers with different interests. In one embodiment, a sporting goods store may create one offer intended for golf enthusiasts, another offer intended subscribers who have shown an interest in general fitness, and an additional non-specific offer (e.g., a discount coupon) for subscribers who have not previously shopped at the sporting goods store. As will be discussed further, based on user profile information, one embodiment of the LODS 102 will transmit the appropriate mobile content item to the appropriate subscriber.

After associating mobile content items to the geofence or geofences, at 216 the LODS 102 generally associates the default geofence, custom geofence, or concentric geofences with the user-selected property and stores the information in a database for subsequent use and/or processing.

As noted above, in one embodiment, when the system 102 determines a user 128 desires to create a custom geofence or multiple geofences, the system 102 transitions to the custom geofence creation process 300, as shown in FIG. 3 embodiment. Moving to FIG. 3A, at operation 305, the system 102 receives a user's indication of whether the geofence is to be circular. As discussed previously, geofences can take on any user-specified shape (e.g., rectangle, square, trapezoid, polygon, etc.), but in one aspect, circular geofences serve as the default shape.

If the system 102 determines the user wants to create a custom circular geofence, at operation 325, the system 102 receives radius information for the circular geofence. As noted above in relation to FIG. 2, the system 102 receives the user's property selection at 210. In one embodiment, the map coordinates or “point” associated with that property (i.e., latitude and longitude), serve as the center point for the circular geofence. As previously noted, in one embodiment, a user may select a “point” that is not associated with a property or designated marketing area. In such embodiments, the unassociated point serves as the center point for the circular geofence. The radius information received at 325, coupled with the map coordinates, then serve to define the circular geofence surrounding the property or other user-specified location. In one embodiment, a user 128 may define the radius by utilizing a user interface. According to one aspect, the user interface may allow a user to select a point on a map to define the radius. In other aspects, a user 128 may enter a specific radius length or choose a predefined length from a dropdown menu.

As shown in the FIG. 3A embodiment, after receiving a user's radius information, at operation 330, the system 102 stores the information, and at operation 335, the system 102 receives information indicating whether the user wishes to create additional geofences associated with the property specified at 210. As discussed previously, in one embodiment, users can associate concentric geofences (i.e., geofences of progressively-increasing diameters) to a particular location (e.g., retailer, shopping center, street address, etc.). As will be understood and appreciated, concentric geofences allow a user to create various coupons, rewards, and/or content (collectively, “mobile content items”) to which subscribers are entitled to receive on their mobile device depending on which geofence they enter (i.e., depending on how close the subscriber's proximity is to the retailer, shopping center, etc.). For example, referring back to the FIG. 1 environment, concentric geofences 122A and 122B encircle store 126A. In one embodiment, a representative of store 126A could specify that subscribers entering geofence 122B (e.g., subscriber 130B) receive marketing content such as a message indicating store 126A is holding a sale. According to one embodiment, the representative of store 126A could further specify that subscribers entering geofence 122A (e.g., subscriber 120A) receive a coupon for an additional 15% discount. As will be understood and appreciated, a user could associate any number of geofences with a particular location.

As shown in the FIG. 3A embodiment, if the system 102 receives indication that the geofence is not going to be circular, at operation 315, the system 102 receives a series of points that define the geofence. As previously discussed, in one embodiment, points correspond to map coordinates (i.e., a longitude and latitude). Further, as previously noted, the geofence can take on any user-specified shape (e.g., rectangle, square, trapezoid, polygon, etc.). Once the user has defined the particular geofence, at operation 320, the system 102 receives indication as to whether the user desires to create additional non-circular geofences. Once the system 102 receives an indication that the user does not desire to create additional non-circular predefined regions, the system 102 proceeds to operation 340, as shown in the FIG. 3A embodiment.

Once the system 102 receives an indication that the user does not desire to create additional geofences, at operation 340, the system 102 receives geofence priority information and assigns the priority information to the respective geofences. In one embodiment, concentric geofences are layered on top of one another. Referring back to FIG. 1, geofence 122B overlays geofence 122A (or, conversely, 122A overlays 122B). According to one embodiment, at operation 340, the user who created geofences 122A and 122B specifies the priority of 122A and 122B. For example, the user may specify that geofence 122A has priority over geofence 122B. In such a case, a subscriber entering geofence 122A (i.e., the geofence with higher priority) may be entitled to a more-desirable reward or coupon. In an alternate embodiment, the user may specify that geofence 122B has priority over geofence 122A.

In one embodiment, after assigning geofence priority, the system proceeds to operation 345, as illustrated in the FIG. 3B embodiment. At operation 345, the system 102 receives an indication as to whether the user desires to create a negative geofence, which the system then creates at operation 350. In one embodiment, a negative geofence is any area that falls outside of the largest geofence or other predefined area associated with a particular property, location, or other point. For example, in the FIG. 1 embodiment, the negative geofence would be the entire environment, falling outside of geofence 122B. As will be understood and appreciated, users who define concentric geofences may associate certain mobile content items with the respective geofences, but they may also wish to provide a mobile content item to subscribers who do not enter one of the predefined regions. In one example, a user may associate a message with a negative geofence that is delivered to the mobile device of certain subscribers in an effort to encourage those subscribers to visit the user's store or retail location. As shown in the FIG. 3B embodiment, after defining the negative geofence (or after receiving indication that the user does not desire to create a negative geofence), the system 102 proceeds to operation 215, as previously discussed.

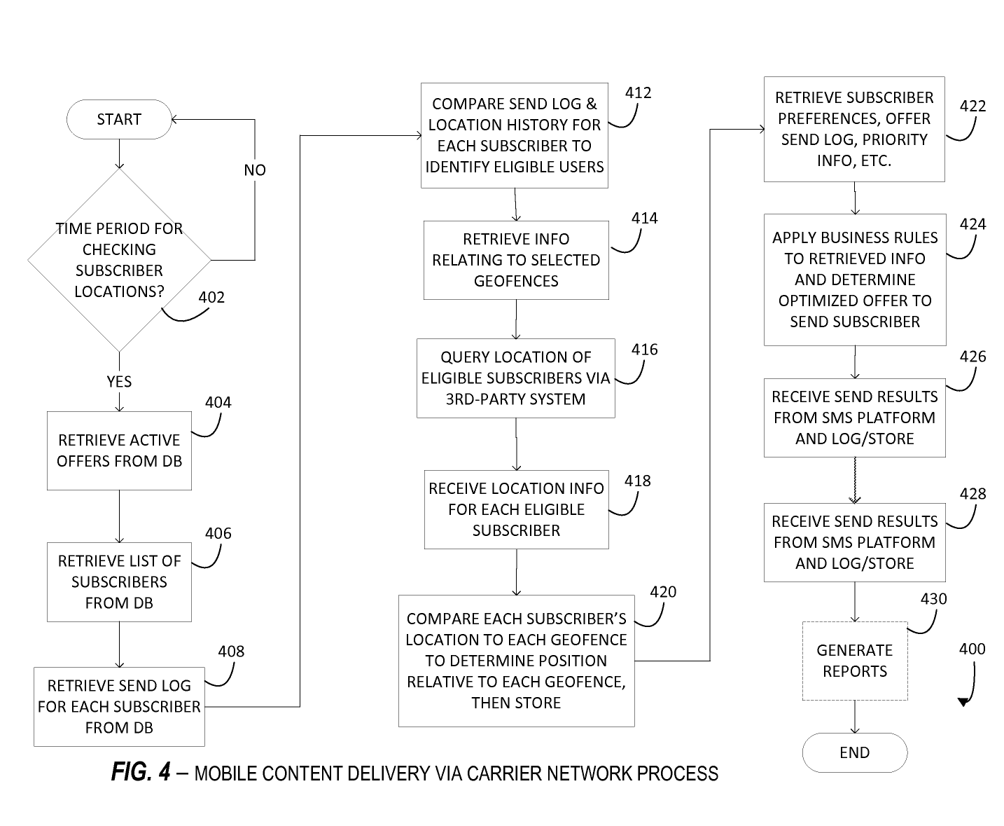

FIG. 4 illustrates an exemplary process 400 performed by various modules and software components associated with an embodiment of an LODS 102 for purposes of receiving location information relating to subscribers, determining optimized mobile content items for delivery to subscribers, and forwarding offers or mobile content items to an SMS Platform to be delivered to subscribers. In one further embodiment, mobile content items may be delivered directly to a mobile application on a subscriber's mobile device via push notification. As will be understood, the operations of the process shown in FIG. 4 and various processes of an LODS 102 may operate concurrently and continuously. Accordingly, the operations shown in FIG. 4 are generally asynchronous and independent, computer-implemented, tied to particular machines, and not necessarily performed in the order shown.

Starting at operation 402, the LODS 102 verifies whether or not the time period is appropriate for checking subscriber locations. According to one aspect, an LODS 102 is preconfigured to retrieve active offers from a database after a predetermined amount of time such as 30 seconds, one minute, five minutes, etc. According to a further aspect, users provide dayparting information to specify particular times that offers can be sent to subscribers. For example, users may specify that offers should only be sent to subscribers between 8 a.m. and 8 p.m. Therefore, according to one embodiment, before checking subscriber locations, the LODS 102 verifies that the current time falls into the appropriate time window. If the LODS 102 determines that the current time does not fall into the appropriate time window, the LODS 102 continues checking the time. If the LODS 102 determines the time does fall into the appropriate time window for checking subscriber locations, however, the process continues to operation 404.

At operation 404, the LODS 102 retrieves active offers from a database. According to one embodiment, offers are specified to be distributed during a predefined time period during a particular day and also between specified dates. For example, a user may specify that a particular offer is to be distributed every day from Sep. 1, 2012, to Sep. 31, 2012, between 8 a.m. and 8 p.m. On, for example, Sep. 14, 2012, at 10:38 a.m., the above-mentioned offer would be considered an “active offer” and would thus be retrieved from the database by the LODS 102 at operation 404.

Next, at operation 406, and according to certain embodiments, an LODS 102 retrieves a list of subscribers from a database. According to one embodiment and as will be understood, “subscribers” are consumers who have completed an opt-in process wherein they agree to have their locations tracked to participate in location-based (i.e., geofencing) mobile device alert programs (e.g., SMS message alerts, MMS messages, emails, mobile application push notifications, etc.). According to one aspect, consumers may complete an opt-in process via a mobile device or via an Internet website. Typically, and according to one aspect, during an opt-in process, consumers provide certain identifying information such as mobile phone number, email address, zip code, gender, offer and retailer preferences, and other such information as will occur to one of ordinary skill in the art.

Moving to operation 408, according to one embodiment, the LODS 102 retrieves from a database a send log for each subscriber for which information was retrieved in operation 406 as described above. According to one aspect, an upon forwarding an optimized offer for a particular subscriber, the LODS 102 creates an entry in a send log indicating the subscriber was forwarded an offer. As will be understood, a send log may also include further identifying information such as the date and time the offer was forwarded, the user who generated the offer, and other information that will occur to one ordinarily skilled in the art. According to one embodiment, the LODS 102 limits the number of offers forwarded to a subscriber during a certain time period. For example, they system may limit each subscriber from being forwarded more than four offers during any one-month period.

Still referring to FIG. 4, after retrieving send logs for each subscriber, the LODS 102 generally retrieves from a database location history for each subscriber. According to one embodiment, as discussed previously, upon completing an opt-in process, subscribers agree to have their location tracked. According to one aspect, each time a subscriber's location is queried (as will be discussed further in relation to operation 416), such location data for each subscriber is stored in a database as location history for use in determining optimized offers for forwarding.

Upon retrieving the send log and location history for each subscriber, the LODS 102 generally compares the send log and location history for each subscriber to predetermined rules regarding when offers should be sent to certain subscribers to identify eligible subscribers, i.e., subscribers who are eligible to be forwarded offers, as shown at operation 412. According to certain embodiments and as will be understood of one skilled in the art, there is a monetary cost associated with querying a third-party system (i.e., location provider) for location information for eligible subscribers (as will be discussed further in relation to operation 416). To reduce unnecessary queries, according to one aspect, the LODS 102 compares the send log and location history for each subscriber to determine (A) which subscribers are eligible to receive offers (i.e., which subscribers have not already been forwarded the maximum number of offers for a designated time period) and (B) which subscribers are likely to be in the same proximity as users presenting an offer. For example, according to one embodiment, a subscriber who has not yet received the maximum number of offers for a designated time period would be an eligible subscriber; however, if the location history indicated that two hours earlier the subscriber was in San Francisco, Calif., the subscriber likely would not be eligible for an offer in Miami, Fla. As will be appreciated, it would be unlikely that the subscriber had traveled from San Francisco to Miami in two hours; therefore, querying the subscriber's location would be an inefficient use of resources. Instead, according to one embodiment, at operation 412, the LODS 102 would rule the subscriber was not an eligible subscriber based on predetermined rules relating to subscriber location.

After identifying eligible users, at 414 the LODS 102 generally retrieves geofence information relating to users with active offers (as retrieved in operation 404). As previously discussed geofences (or predefined regions) are virtual perimeters around locations such as stores, restaurants, shopping malls, etc., wherein the location itself is defined as a “point.” According to one aspect (and as discussed above), a geofence can be a circumference around a particular location (point) wherein the location itself serves the center of a circle, and the circumference of the geofence can be based on a user-defined perimeter. According to another aspect, a location (point) can be located inside a trapezoid- or polygon-shaped geofence. As will be understood by one of ordinary skill in the art, geofences can take various shapes and encompass various amounts of area depending on the needs of the particular user defining the geofence.

Moving to operation 416 as shown in FIG. 4, according to one embodiment, the LODS 102 interacts with a third-party provider to query the location of eligible subscribers. As discussed previously, according to one embodiment, eligible subscribers are subscribers who have not yet been forwarded their maximum allotment of offers for a specified time period and who have been deemed eligible by the LODS 102 based on their location history (as discussed in relation to operation 412, above). As will be understood by one skilled in the art, a third-party provider queries location information of eligible subscribers based on information broadcast associated with the subscribers' mobile devices.

After a third-party provider queries the location information of the eligible subscribers, according to one embodiment, the LODS 102 receives said location information, as shown in operation 418. Upon receipt of said location information, at operation 420 and according to one embodiment, the LODS 102 compares the location information to the geofence location retrieved at 414. According to one aspect, the system 102 compares the subscriber location information to each of the selected geofences to determine a subscriber's position relative to each geofence. The system 102 then stores each of the subscriber's positions relative to each of the geofences, according to one aspect. According to one aspect, the LODS 102 may determine a subscriber to be inside a geofence, outside a geofence, a particular distance from a geofence, “close enough” to a geofence (based on certain predetermined rules), or other position relative to a geofence as will occur to one skilled in the art.

According to one embodiment, after storing the relative position information as determined, at 422 the LODS 102 then retrieves from a database various types of information for use in determining optimized offers to be sent to subscribers (as will be discussed in relation to operation 424). As will be understood, such information may include subscriber preferences relating to categories of products, including, for example, clothing, shoes, electronics, sporting goods, and other categories as will occur to one skilled in the art. Such information may also include offer priority information. According to one aspect, users may choose to pay a pre-determined fee to have “high priority” status applied to their offers. According to one aspect, the LODS 102 uses an offer's priority status when determining which offers to forwarded to a subscriber. In certain aspects, offers with high priority status are more likely to be forwarded to subscribers than offers without high priority status. Further, at 422, the LODS 102 may retrieve offer send log information. According to one aspect, absent high priority status, the LODS 102 may attempt to forward the least-forwarded offer to a subscriber, which is still appropriate for the subscriber based on the subscriber's settings. The aforementioned information categories are simply examples, and as will be understood, the LODS 102 may also retrieve from a database other information for use in determining optimized offers to be sent to a subscriber, as will occur to one skilled in the art.

After retrieving the relevant information, at 424, according to one embodiment, the LODS 102 generally applies business rules to said retrieved information for determining an optimized offer to send to a subscriber. As discussed previously, according to certain aspects, business rules may consider offer priority information, subscriber preference information, offer send log information, and other information that will occur to one skilled in the art when determining optimized offers to send to subscribers. After determining an optimized offer to send, according to one embodiment, the LODS 102 then forwards the optimized offer selection to an SMS platform for delivery to a designated subscriber, as shown at operation 426. As will be understood by one skilled in the art, an SMS platform receives offer messages from the LODS 102 and transforms the message into an SMS message that can be received on a subscriber's mobile device.

In one embodiment, subscribers may receive one offer message when they are outside a geofence because, for example, the subscriber has not been in a geofence for an extended period of time, has not received an offer for an extended period of time based on subscriber preferences, etc., based on business rules. According to one aspect, subscribers outside a particular geofence may receive one offer relating to the geofence while subscribers inside the geofence may receive a different offer relating to the geofence. According to another aspect, concentric circular geofences may surround a particular property, and subscribers in an outer geofence may receive different offers from subscribers inside the innermost geofence.

Next, at 428, according to one embodiment, after forwarding an optimized offer selection to an SMS platform, the LODS 102 typically receives send results from the SMS platform, which the LODS 102 then stores. As will be understood by one skilled in the art, after sending an optimized offer selection to a subscriber, an SMS platform may generate certain send results. Generally, such send results include information such as the time the message was sent, the time the message was delivered, a delivery confirmation, the location of the subscriber at the time of message delivery, the mobile phone number of the subscriber, and other information as will occur to one skilled in the art.

Finally, at optional 430, an LODS 102 may generate various reports or logs based on the send results received from an SMS platform at operation 428 and various other information relating to offers sent by the LODS 102, as will occur to one skilled in the art.

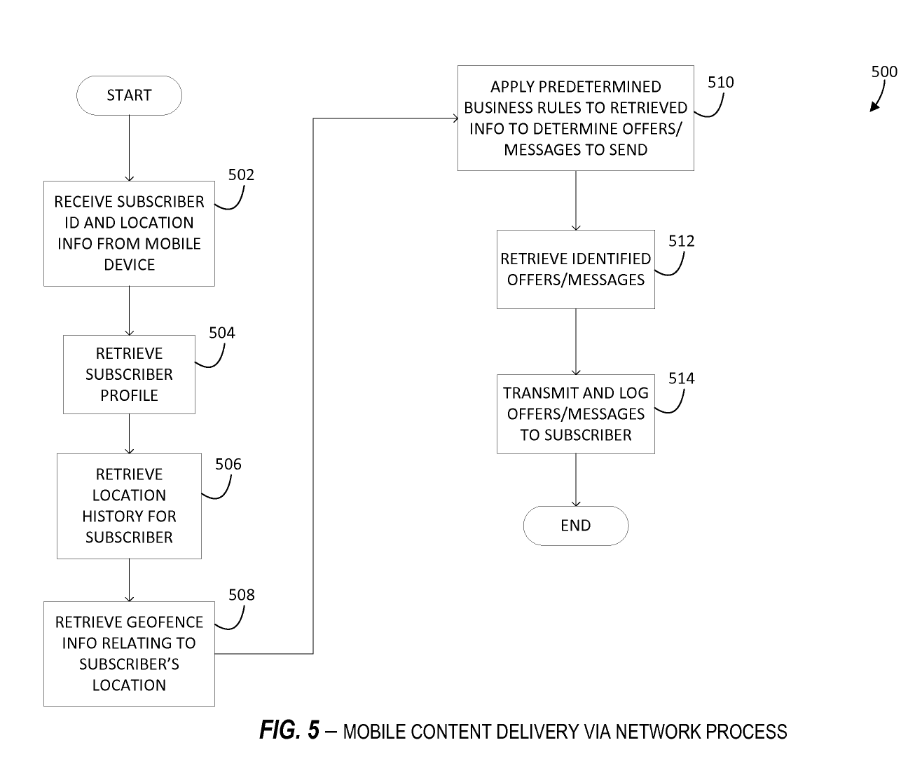

FIG. 5 illustrates an exemplary process 500 performed by various modules and software components associated with an embodiment of an LODS 102 for purposes of receiving subscriber location information and determining mobile content items for delivery to subscribers via push notification to a mobile application.

According to the FIG. 5 embodiment, at 502, the system 102 receives subscriber identifying information and information relating to the subscriber's location from the subscriber's mobile device. As discussed previously, the location information may be received from the device's GPS or A-GPS service, from an IP address associated with the device, from Google Services, based on a Wi-Fi access point, etc. Based on the received subscriber identifying information, at 504 the system 102 retrieves a subscriber profile associated with the subscriber. As discussed previously, a subscriber profile may include subscriber preferences relating to categories of products, including, for example, clothing, shoes, electronics, sporting goods, and other categories. Further, a subscriber profile may include historical information acquired by the system 102. According to one aspect, for example, if a particular subscriber's has shown a proclivity to utilize mobile content items relating to golf (e.g., discount coupons at golf courses or driving ranges, purchases at golf sporting goods stores, etc.), that subscriber's profile may indicate the subscriber is an avid golfer. According to an additional aspect, a particular subscriber may have utilized multiple mobile content items from a particular restaurant at a particular time of day, which may suggest the subscriber frequents the establishment on the way home from work. The aforementioned non-limiting examples are merely meant to suggest information that may comprise a subscriber's profile, and various other information may be included in such a profile.

Moving to operation 506, according to the FIG. 5 embodiment, the system 102 then retrieves location history associated with the subscriber. In one embodiment, location history may include information relating to locations where the subscriber has redeemed mobile content items in the past. Likewise, location history may relate to various geofences the subscriber has entered or geofences the subscriber has entered a predetermined number of times. As will be understood, various other information may contribute to a subscriber's location history.

At 508, according to the FIG. 5 embodiment, the system 102 then retrieves geofence information relating to the subscriber's current location. As will be understood, a subscriber's position or location may correspond to multiple overlapping geofences associated with multiple locations (i.e., retailers, restaurants, etc.). After retrieving the geofence information relating to the subscriber's current location, at operation 510, the system 102 applies predetermined business rules to the geofence information as well as the subscriber's profile information and location history to determine a mobile content item or items to send to the subscriber. According to one aspect, the system 102 uses the business rules to determine an appropriate mobile content item to deliver to a subscriber based on that subscriber's current location as well as their past activities. For example, a subscriber's location information may suggest the subscriber is within geofences associated with a sporting goods store and a women's clothing store. If the subscriber's profile and location history information indicate the subscriber has utilized a discount coupon to purchase tickets to a baseball game and has redeemed a reward for a free can of tennis balls, the predetermined business rules may suggest that it would be more appropriate to provide the subscriber with a mobile content item associated with the sporting goods store. Further, if there are multiple mobile content items associated with the sporting goods store (e.g., one for golf equipment, one for camping equipment, and one for bicycles), based on the redemption of a reward for free tennis balls, the business rules may determine the mobile content item relating to golf equipment is most appropriate for the particular subscriber. According to one embodiment, if the subscriber's profile and location history are minimal, the system 102 may simply provide a mobile content item from the location to which the subscriber is closest.

According to one embodiment, after applying the predetermined business rules and determining the mobile content items to provide to the subscriber, at 512, the system retrieves the one or more offers. As will be understood, the system 102 may determine one mobile content item to deliver to the subscriber or multiple mobile content items. Then, at 514, the system 102 transmits the one or more mobile content items and logs the transmission. According to one embodiment, the system 102 transmits the mobile content items to the subscriber via push notification to a mobile application on the subscriber's mobile device.

Though not shown, according to one embodiment, the system 102 receives marketing performance data or other indications when a subscriber users, views, redeems, or otherwise engages with a mobile content item. According to one aspect, such marketing performance data is further indicative of a subscriber's habits or preferences and can be incorporated into the subscriber's profile.

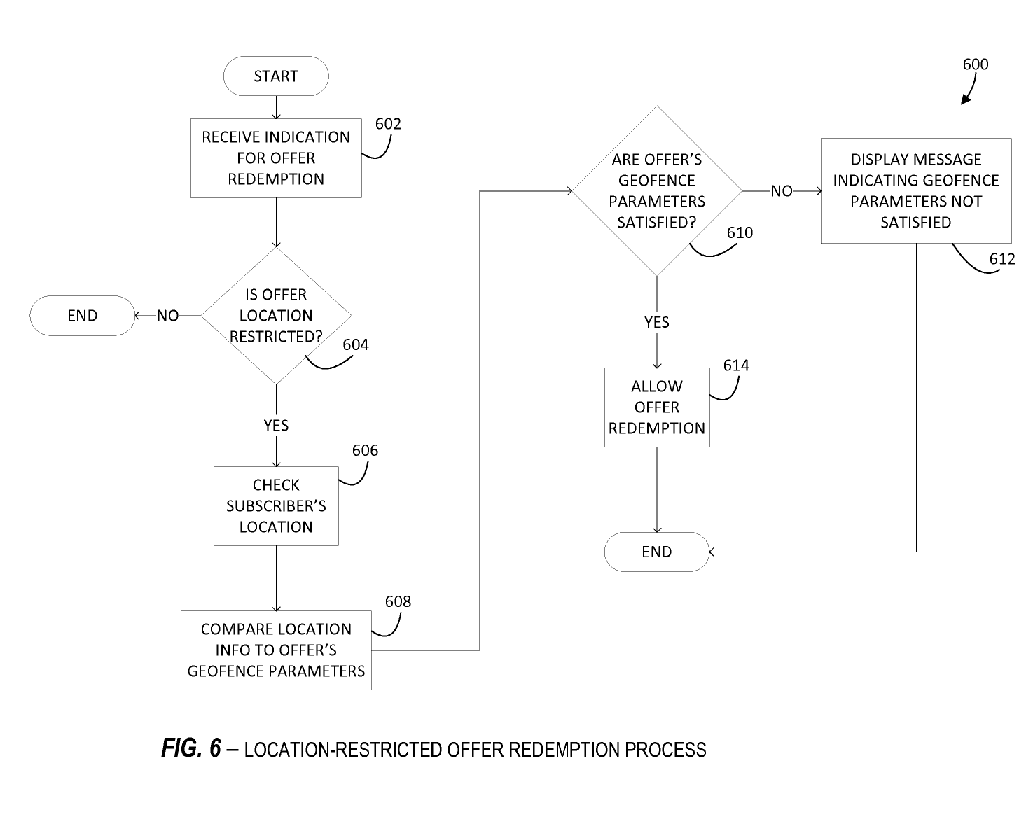

FIG. 6 illustrates an exemplary process 600 performed by various modules and software components associated with an embodiment of an LODS 102 for purposes processing and confirming the redemption of a location-restricted offer. According to one embodiment, a location-restricted offer is an offer that is only redeemable at a particular location. For example, a restaurant chain may have ten locations in a particular city. One of the ten restaurants may choose to offer a location-restricted offer that is only redeemable at their specific location. of receiving subscriber location information and determining mobile content items for delivery to subscribers via push notification to a mobile application.

According to the FIG. 6 embodiment, at 602, the system 102 receives an indication that a subscriber is attempting to redeem an offer. At 604, the system 102 determines whether the offer is location-restricted. If the offer is location-restricted, at 606, the system 102 checks the subscriber's location. As previously discussed, such location information may be received from the device's GPS or A-GPS service, from an IP address associated with the device, from Google Services, based on a Wi-Fi access point, etc. After receiving the subscriber's location information, in one embodiment, the system 102 compares the location information to the location-restricted offer's geofence parameters at operation 608. For example, to confirm that the subscriber is actually at the specified location, the offer may specify that the user's location must be within a specified distance from the center point of the geofence. Alternatively, the offer may specify that the subscriber simply needs to be inside a geofence associated with the location.

According to one embodiment, after comparing the location information to the offer's geofence parameters, the system 102 determines if the parameters are satisfied at 610. In one embodiment, if the offer's geofence parameters are not satisfied, at 612 the system 102 transmits a message to be displayed on the subscriber's mobile device indicating the reward has not been redeemed. According to one aspect, this message may indicate that the offer has not been redeemed because the subscriber's location information indicates the subscriber is not at the proper location. If, on the other hand, the parameters are satisfied, the system 102 allows or confirms the offer redemption at operation 614.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. In a Location-based Offer Delivery System (LODS), wherein the LODS includes an LODS central server for performing various operations of the LODS, and wherein the LODS is in operative communication with a plurality of subscribers operating a plurality of mobile devices for receiving mobile content items, and wherein a user of the LODS indicates a desire to create a plurality of predefined regions, a method comprising:
receiving at the LODS central server a particular location identifier corresponding to a particular geographic location;
receiving at the LODS central server first radius information defining a radius of a first predefined region, wherein the particular location identifier comprises the center point of the first predefined region;
associating a first set of one or more mobile content items with the first predefined region;
receiving at the LODS central server second radius information defining a radius of a second predefined region, wherein the particular location identifier comprises the center point of the second predefined region;
associating a second set of one or more mobile content items with the second predefined region; and
receiving at the LODS central server priority information establishing a hierarchical relationship between the first predefined region and the second predefined region for determining delivery of the first set and the second sets of one or more mobile content items, whereby the first and second sets of one or more mobile content items are transmitted to subscribers' mobile devices based on locations of the subscribers with respect to the first and second predefined regions.

2. The method of claim 1, further comprising:
receiving at the LODS central server subscriber identification information and mobile device location information corresponding to a particular subscriber associated with a particular mobile device indicating the particular subscriber has entered either the first or second predetermined region;
retrieving one or more mobile content items for delivery to the particular mobile device associated with the particular subscriber; and
transmitting from the LODS central server the retrieved one or more mobile content items to the particular mobile device associated with the particular subscriber.

3. The method of claim 2, wherein mobile device location information comprises a longitude and latitude.

4. The method of claim 2, wherein mobile device location information is determined via a service selected from the group comprising: GPS, A-GPS, IP address, Wi-Fi, Google Services.

5. The method of claim 2, further comprising:
logging at the LODS central server the one or more mobile content items transmitted to the particular mobile device associated with the particular subscriber.

6. The method of claim 2, wherein transmitting the retrieved one or more mobile content items to the particular mobile device associated with the particular subscriber is accomplished via a wireless communication protocol.

7. The method of claim 2, further comprising:
receiving at the LODS marketing performance data indicating subscriber interaction with mobile content items; and
updating subscriber profiles based on the received marketing performance data, wherein the updated consumer profiles are further indicative of subscriber behavior and preference.

8. The method of claim 7, wherein subscriber behavior comprises one or more of: physical movement of subscribers, relative success of mobile content items, buying patterns of subscribers, buying preferences of subscribers.

9. The method of claim 1, further comprising:
receiving at the LODS central server information defining a third predefined region, wherein the third predefined region does not overlap the first predefined region or the second predefined region; and
associating a third set of one or more mobile content items with the third predefined region.

10. The method of claim 9, wherein the third predefined region is a negative geofence.

11. The method of claim 1, wherein mobile content items are selected from the group comprising: discount coupon, reward, message, image, mobile webpage.

12. The method of claim 1, wherein mobile content items are associated with associated with a particular system user.

13. The method of claim 12, wherein the particular system user is a representative of one or more of: retail locations, resorts, casinos, merchant locations, shopping malls, hospitals, airports, universities, office buildings, restaurants.

14. The method of claim 1, wherein a particular mobile content item is pre-created by particular system user.

15. The method of claim 1, wherein predefined region information corresponds to a geofence.
